(19) United States
(12) Patent Application Publication
(10) Pub. No.: US 2011/0048654 A1
(43) Pub. Date: Mar. 3, 2011

(54) METHOD AND DEVICE FOR MANIPULATION WITH THERMO-INSULATING COVER OF MASSAGE POOL OR SWIMMING MASSAGE POOL

(76) Inventor: Petr Kolar, Dolni Dobrouc (CZ)

(21) Appl. No.: 12/988,668

(22) PCT Filed: Apr. 16, 2009
(86) PCT No.: PCT/CZ2009/000052

§ 371 Date: Oct. 20, 2010

(30) Foreign Application Priority Data
Apr. 22, 2008 (CZ) PV 2008-243

(51) Int. Cl. E05F 15/02; E05F 11/02

(52) U.S. Cl. 160/188; 160/405

(57) ABSTRACT

The present disclosure relates to the method and device for manipulation with thermo-insulating cover (4) of massage pool or swimming massage pool (1) between its covering position and opened position and vice versa, while the thermo-insulating cover (4) comprises at least one pair of thermo-insulating segments (41, 42) formed of carrier thermo-insulating segment (41) and carried thermo-insulating segment (42), which are together rotatably connected and in covering position are lying by their bottom surfaces (411, 421) on circumference of the massage pool (1), while the carrier thermo-insulating segment (41) is rotatably mounted on the massage pool (1). At transition from covering into opened position the angle, which is formed by bottom surfaces (411, 421) of thermo-insulating segments (41, 42) of a pair of thermo-insulating segments (41, 42), decreases from 180° in covering position to 0° in opened position, in which originally bottom surfaces (411, 421) of both thermo-insulating segments (41, 42) mutually touch, and during transition from opened into covering position the angle, which is formed by the bottom surfaces (411, 421) of thermo-insulating segments (41, 42), increases from 0° to 180°.

### TECHNICAL FIELD

The invention relates to the method for manipulation with thermo-insulating cover of massage pool or swimming massage pool between its covering position and opened position and vice versa, while the thermo-insulating cover comprises at least one pair of thermo-insulating segments formed of carrier thermo-insulating segment and carried thermo-insulating segment, which are together rotatably connected and in covering position are lying by their bottom surfaces on circumference of the massage pool, while the carrier thermo-insulating segment is rotatably mounted on the massage pool.

The invention further relates to the device for manipulation with the thermo-insulating cover of the massage pool or swimming massage pool between its covering position and opened position and vice versa, while the thermo-insulating cover comprises at least one pair of thermo-insulating segments formed of carrier thermo-insulating segment and carried thermo-insulating segment, which are together rotatably connected and in covering position are lying by their bottom surfaces on circumference of massage pool, while the carrier thermo-insulating segment is rotatably mounted on the massage pool.

### BACKGROUND ART

At present, there exists a number of types of massage pools designated also as whirlpools and swimming massage pools or swim spa, which are the massage pools of larger dimensions suitable especially for active swimming. Massage pools serve for relaxation and rehabilitation, they are also accessories of family houses and villas, both in interior and exterior. Ground plan size of massage pools is about from 1×2 m, up to 3×6 m at swimming massage pools. The structure of massage pool is designed so that the water may remain clean and warm for a long time. For this purpose there is insulated structure of shell and the thermo-insulating cover, which prevents leakage of moisture and heat from the massage pool, thus reducing the operation costs, next to this, it prevents injury of small children and pets, protects the massage pool against entering of impurities and dust and prevents penetration of solar radiation causing reproduction of micro-organisms in water. Thermo-insulating covers are yet produced from a light material, nevertheless with respect to dimensions, still their weight is relatively high, which makes difficult to manipulate with these covers. The most frequently used thermo-insulating covers consist of two thermo-insulating segments, which are mutually rotatably connected and which from the covering position into opened position and vice versa are transferred manually. In covering position, at the beginning of manipulation one thermo-insulating segment is tilted to the other one, so that they are touching by their originally upper sides and consequently they are transferred, at the same time for transferring usually two persons are necessary. Another disadvantage of manual transferring of the thermo-insulating cover is the problem with storage of thermo-insulating cover when the massage pool is used.

Therefore there were developed devices for manipulation with segments of thermo-insulating covers between their covering position and opened position, both the manually controlled mechanical devices and semi-automatic devices, and also the automatic devices reacting only to command from an operator.

For example U.S. Pat. No. 5,689,841 discloses the mechanism for lifting the two-segment thermo-insulating cover from a massage pool or from swimming massage pool by means of a device, which is provided on the first thermo-insulating segment being rotatably connected with massage pool. As indicated in column 5 of invention description, upon transferring the thermo-insulating cover into a put-off position, at first the second thermo-insulating segment is lifted and it is tilted over the first thermo-insulating segment, so that they touch with their originally upper sides. After then the first thermo-insulating segment is lifted together with the second thermo-insulating segment by means of lifting device into vertical position, by which the massage pool is uncovered.

Similar mechanisms are described e.g. in documents U.S. Pat. No. 6,795,984, US2007/0209104 and US6000071. At all these solutions the thermo-insulating cover remains at the time when the massage pool is used on edge of the massage pool in vertical position, thus in the put-off position, in which it prevents access to the massage pool from one of its side and restricts the view. Storage of thermo-insulating cover during usage of the massage pool in other position is partially solved e.g. by the solutions disclosed in U.S. Pat. No. 7,155,756, U.S. Pat. No. 5,048,153, U.S. Pat. No. 5,974,600 or WO2007/058953, at which after lifting the thermo-insulating cover from the upper circumference of the massage pool it is lowered or dropped into a space outside the ground plan of massage pool, e.g. next to the rear wall of the massage pool. Like at the above mentioned solutions, it is first necessary to tilt the second thermo-insulating segment over the first thermo-insulating segment so that they touch by their originally upper sides, which is in most cases performed manually. Still there remains problem as to difficult manipulation with the thermo-insulating cover whose weight is considerable.

U.S. Pat. No. 7,155,756 discloses mechanism for automatic bending of the second thermo-insulating segment over the first thermo-insulating segment into a position described at the above mentioned solutions. This mechanism is relatively complicated and places great demand to the structure of the whole lifting device, through which also its acquisition and operational costs are increased, at the same time an aesthetic impression is worsened. All devices for manipulation with thermo-insulating covers according to the background art must be dimensioned for lifting of a total weight of both thermo-insulating segments or for rotation of total weight of both thermo-insulating segments, so that they are rugged and their price is increased.

PV2006-416 discloses totally different manner of manipulation with thermo-insulating cover. The described thermo-insulating cover consists of more thermo-insulating segments, which are coupled with means for their displacement between the covering position and opened position, while in the covering position each thermo-insulating segment is positioned on perimeter of the massage pool and in the storage position the thermo-insulating segment is stored outside the ground plan of the massage pool. The means for displacing the thermo-insulating segments may e.g. be a hinged mechanism, by means of which each thermo-insulating segment is lifted and displaced into storage space outside the ground plan of the massage pool. Individual segments positioned in storage space fit together mutually, and in the covering position they create a compact cover. This method of lifting the thermo-insulating cover is suitable especially for the massage pool with shaped upper circumference. The disadvantage is splitting the cover into a quantity of thermo-insulating segments, difficult manipulation with these segments and due to this a higher price of the cover as well as of the whole massage pool.

The goal of the invention is to develop a simple and physically not demanding method for manipulation with the thermo-insulating cover of massage pool between its covering position and opened position with minimum energy developed by an operator or an attending device, and possibly to secure storage of the thermo-insulating cover during usage of the massage pool.

### PRINCIPLE OF THE INVENTION

The goal of the invention has been achieved by a method according to the invention whose principle consists in that at transition from covering into opened position the angle, which is formed by bottom surfaces of thermo-insulating segments of a pair of thermo-insulating segments, decreases from 180° in covering position to 0° in opened position, in which originally bottom surfaces of both thermo-insulating segments mutually touch, and during transition from opened into covering position the angle, which is formed by the bottom surfaces of thermo-insulating segments increases from 0° to 180°.

The method according to the invention enables more simple manipulation with the thermo-insulating cover, especially its mechanisation and automatization.

To reduce the demand for driving of the carrier thermo-insulating segment, the carried thermo-insulating segment at least on a section of its track moves by its free wall on perimeter of the massage pool.

Upon the carrier thermo-insulating segment, with advantage, the rotating drive is acting, which may be direct or through action of a suitable known gear mechanism.

At the same time the rotation drive may be manual or electrical one.

According to the claim 6 upon the carrier thermo-insulating segment by a force via the carried thermo-insulating segment is acted.

The principle of the device according to the invention consists in that the device comprises means for decreasing an angle between the bottom surfaces of thermo-insulating segments from 180° to 0° at opening the thermo-insulating cover, and for increasing of this angle from 0° to 180° upon closing the thermo-insulating cover.

The means to change an angle between the bottom surfaces of thermo-insulating segments are formed of rotating drives arranged on both sides of carrier thermo-insulating segment.

To facilitate the motion of the carried thermo-insulating segment before reaching an opened position at opening the thermo-insulating cover, and at the beginning of closing the cover during transition from opened position, the carrier thermo-insulating segment on each its side wall is provided with rotatably mounted air cylinder, whose piston rod at the end is provided with a guide, which is displaceably mounted in guiding arranged on the respective side wall of the carried thermo-insulating segment.

Further features result from dependent claims 10 to 13.

### DESCRIPTION OF THE DRAWING

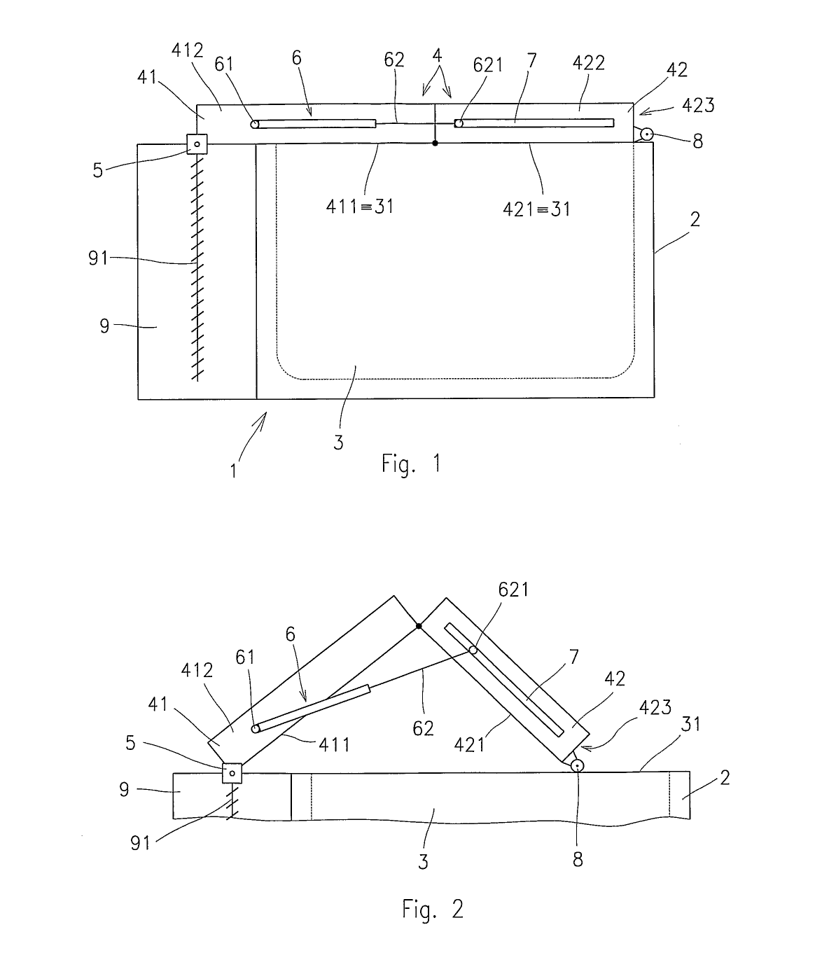

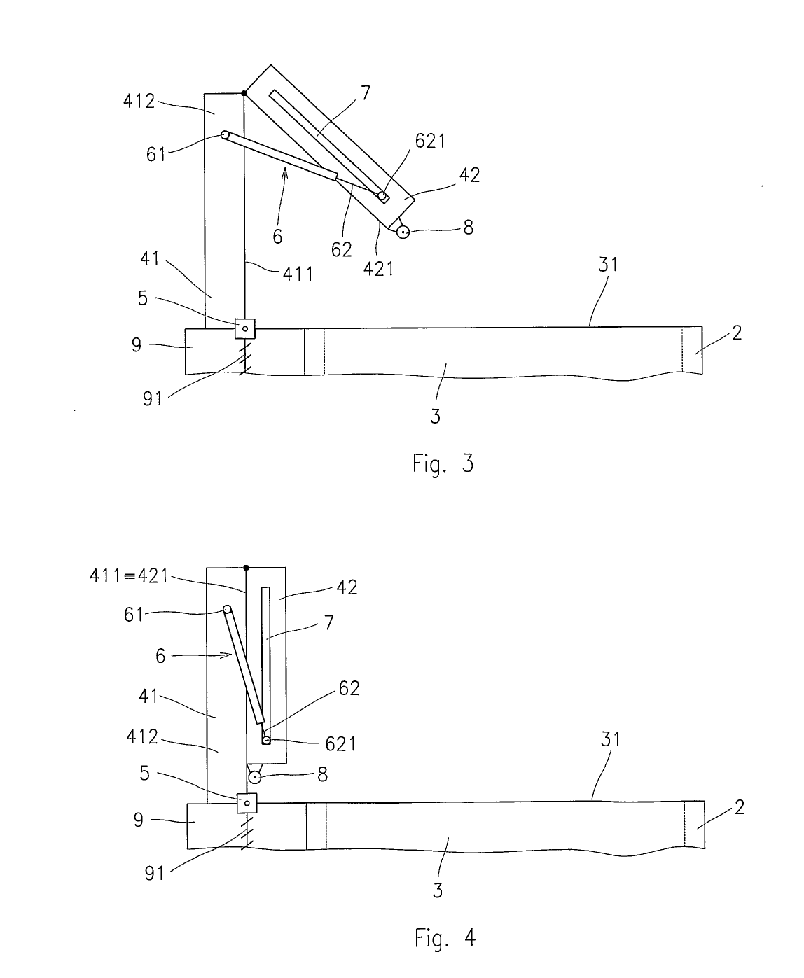

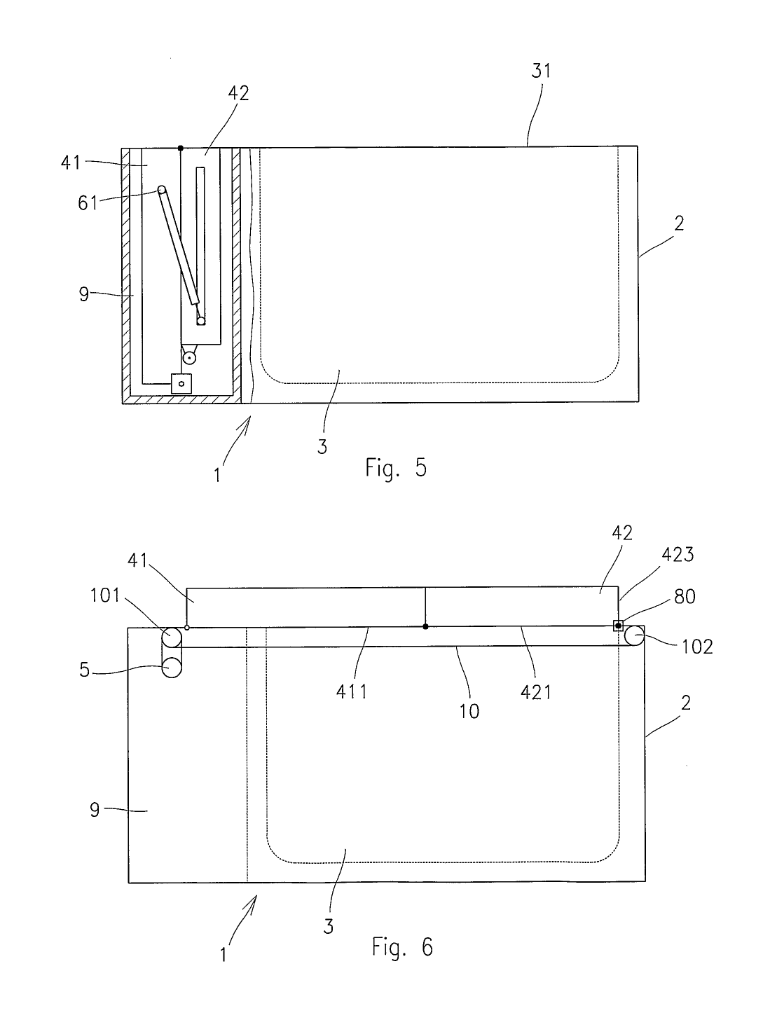

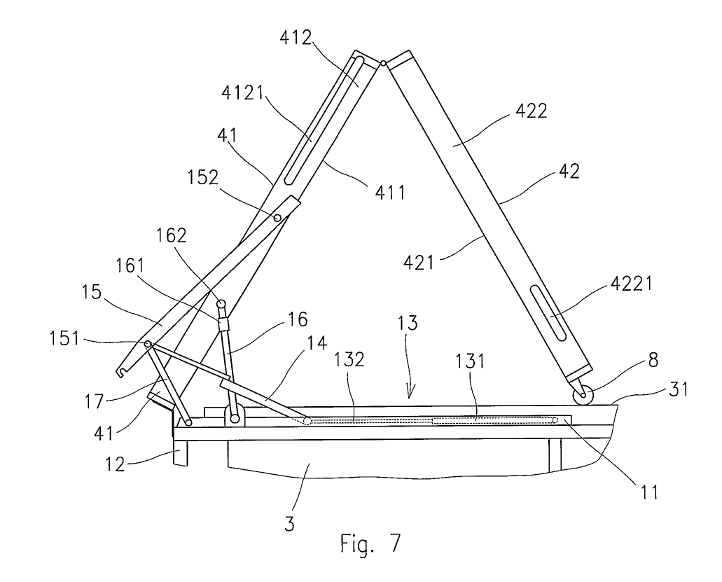

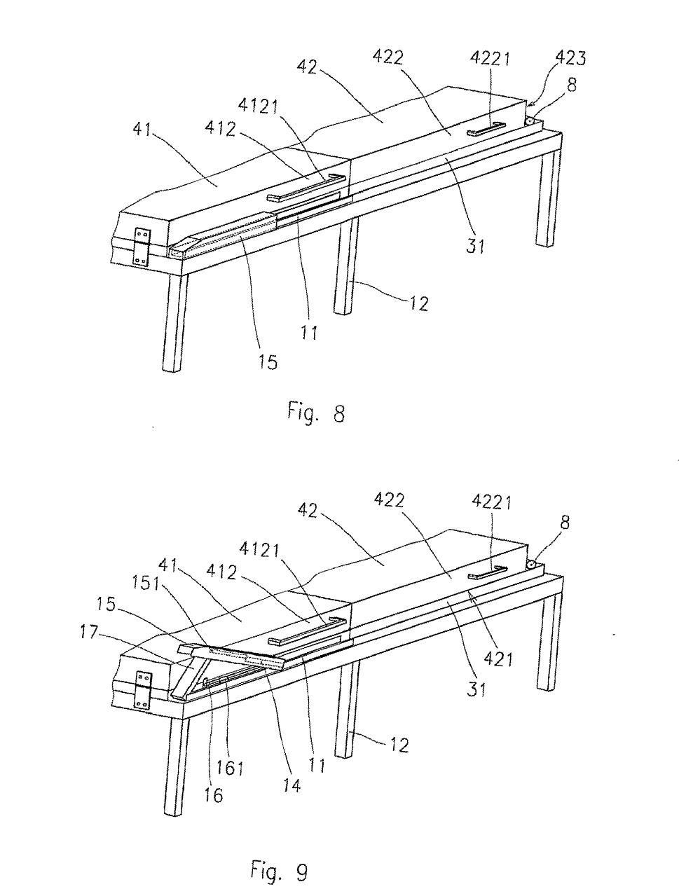

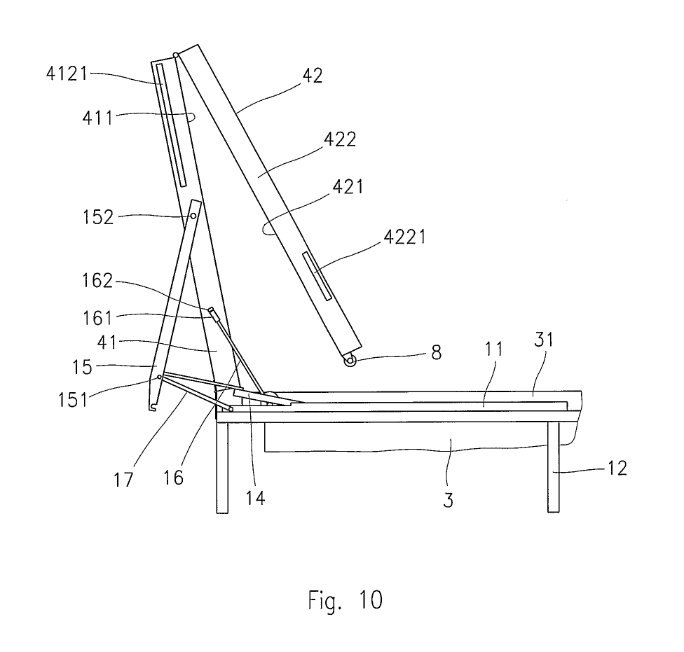

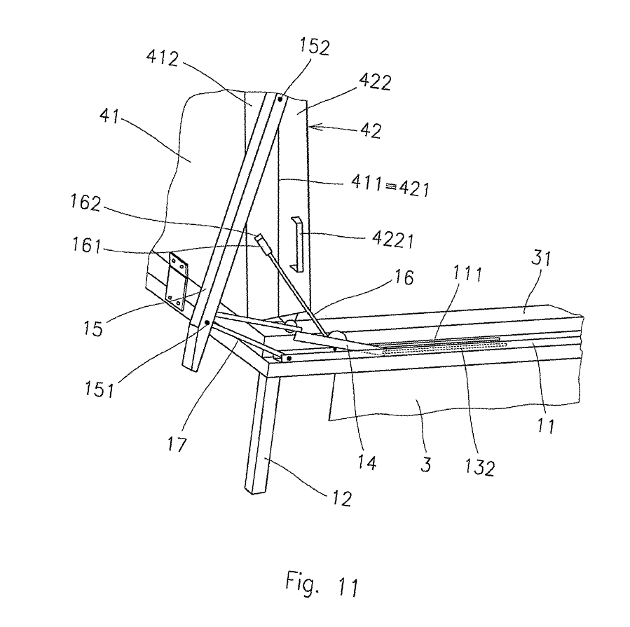

Exemplary embodiments of the invention are schematically represented on drawings, where the FIG. 1 shows massage pool with two-piece thermo-insulating cover in covering position, the FIG. 2 and FIG. 3 shows the massage pool with two-piece thermo-insulating cover between covering position and opened position, the FIG. 4 massage pool with two-piece thermo-insulating cover in opened position, the FIG. 5 massage pool with two-piece thermo-insulating cover in storage position, the FIG. 6 massage pool with manipulation device comprising toothed belt, the FIG. 7 represents the thermo-insulating cover with manually controlled manipulation device, the FIG. 8 massage pool equipped with manually controlled manipulation device with thermo-insulating cover secured in covering position, the FIG. 9 massage pool according to FIG. 8 with thermo-insulating cover in covering position and unlocked manipulation device, the FIG. 10 massage pool according to FIGS. 8 and 9 with thermo-insulating cover before reaching the opened position and the FIG. 11 massage pool according to FIGS. 8 to 10 with thermo-insulating cover in opened position.

### EXAMPLES OF EMBODIMENT

Massage pool 1 according to the FIGS. 1 to 4 comprises the not represented supporting structure provided with the shell 2, which protects parts of the massage pool 1, such as distribution of water to jets, filtration device, etc. Inside the shell 2 in the supporting structure there is mounted the vessel 3 itself of the massage pool, shaped by a suitable manner, which in the upper section is provided with a border 31, arranged in horizontal plane. On the border 31 of vessel of the massage pool there is mounted the thermo-insulating cover 4, that comprises two thermo-insulating segments 41, 42, fitting to the border 31 of vessel of the massage pool all around its circumference by their bottom surfaces 411, 421. Both thermo-insulating segments 41, 42 comprise boards made of thermo-insulating material and in the middle section of the thermo-insulating cover 4 the thermo-insulating segments 41, 42 are together rotatably connected. One of the thermo-insulating segments 41 is the carrier one and it is rotatably mounted on the supporting structure of the massage pool 1 and it is coupled with rotating drive 5. The second thermo-insulating segment 42 is carried due to its rotating connection with the carrier thermo-insulating segment 41 and the rotating motion of the carrier thermo-insulating segment 41. On both side walls 412 of the carrier segment there is rotatably mounted the bushing 61 of double-acting air cylinder 6, whose piston rod 62 at the end is provided with a guide 621, which is adjustably mounted in the guiding 7 arranged on the corresponding side wall 422 of the carried thermo-insulating segment 42. The guiding 7 in the represented embodiment is formed of a groove and the guide 621 may, for example, be formed of a slide or pulley. The air cylinder 6 is with the known not represented manner connected via the control system with the not represented source of compressed air.

In the not represented embodiment the guiding 7 is formed of a rod mounted on the side wall 422 of the carried thermo-insulating segment 42.

The guiding 7 may with the bottom surface of the carried thermo-insulating segment 42 be parallel or it may form with it a sharp angle, whose point may lie both in area of rotation axis of carried thermo-insulating segment 42, and in area of the free wall 423 of the carried thermo-insulating segment 42.

On the free wall 423 of the carried thermo-insulating segment 42 on both sides above the side edges of massage pool 1 are arranged the travelling wheels 8, which are adjusted for travelling on the border 31 of vessel of massage pool or for travelling on a track created in the upper section of the shell 2 of massage pool. The travelling wheels 8 may be replaced by slides or other suitable means.

In covering position, represented in the FIG. 1, both thermo-insulating segments 41, 42 of the thermo-insulating cover are lying on border 31 of the vessel of the massage pool and on the whole perimeter they are seated on it by their bottom surfaces 411, 421. The piston rod 62 of air cylinder is fully extended and the air cylinder 6 is out of function. Similarly, the rotating drive 5 of carrier thermo-insulating segment 41 is also out of function.

Upon requirement for opening of the thermo-insulating cover 4 the rotating drive 5 of the carrier thermo-insulating segment 41 sets into movement in direction of opening and the carrier thermo-insulating segment starts rotating, at the same time its centre section is lifting, on which rotatably is mounted the carried thermo-insulating segment 42, so that its centre section is also lifting and its free wall 423 moves on the border 31 of the vessel of the massage pool. In the represented embodiment on the border 31 of the vessel of the massage pool the travelling wheels 8 are rolling off. At this motion the bottom surface 421 of carried thermo-insulating segment 42 moves in direction to the bottom surface 411 of the carrier thermo-insulating segment 41, while the angle, which together forms the bottom surface 411 of the carrier thermo-insulating segment 41 and the bottom surface 421 of the carried thermo-insulating segment 42 reduces from 180° in covering position to 0° in opened position, when the bottom surfaces 411, 421 of both thermo-insulating segments are seated one to another.

In the first phase the air cylinder 6 remains out of function, its piston rod 62 is still fully extended and the guide 621 at its end moves on the guiding 7 on the side wall of the carried thermo-insulating segment 42 from the centre section of the carried thermo-insulating segment 42 towards its free wall 423 and the bushing 61 of air cylinder on the carrier thermo-insulating segment 41 rotates as it is represented on the FIGS. 1 to 3.

Once the carrier thermo-insulating segment 41 reaches the vertical position, its bottom surface 411 forms with bottom surface 421 of the carried thermo-insulating segment 42 an angle of 30° to 50°, with advantage of 40°, and the guide 621 is to be found at the end of guiding 7 in vicinity of the free wall 423 of the carrier thermo-insulating segment 42. In this position the air cylinder 6 is activated and its piston rod 62 starts to insert into the bushing 61 and the guide 621 pulls the carried thermo-insulating segment 42, till its bottom surface 421 fits to the bottom surface 411 of the carrier thermo-insulating segment 41, by which both thermo-insulating segments 41, 42 reach their opened position. In this position, represented in the FIG. 4, inserting of the piston rod 62 finishes and the air cylinder 6 sets into operation. The piston rod 62 in its inserted position prevents drawing away of the bottom surface 421 of the carried thermo-insulating segment 42 from the bottom surface 411 of the carrier thermo-insulating segment 41.

In opened position both thermo-insulating segments 41, 42 are outside the ground plan of the vessel 3 of the massage pool and under them there is created a storage space 9, in which the means 91 are arranged for lowering and extending of both thermo-insulating segments 41, 42 into and out of the storage space 9. After lowering the thermo-insulating segments 41, 42 into the storage space 9 this space 9 is closed by a known not represented cover and the massage pool 1 is prepared for usage.

The massage pool 1 may be of course used also in opened position of thermo-insulating segments 41, 42. Nevertheless in this position the thermo-insulating segments are above the level of massage pool 1, they prevent the view and restrict the user of the massage pool when entering as well as during motion inside the massage pool.

If the massage pool is of greater dimensions, it is advantageous to arrange on the upper section of the massage pool against each other two pairs of thermo-insulating segments 41, 42, out of which each is arranged identically or similarly as described above.

The structure of device for manipulation with thermo-insulating cover 4 is not limited only to the above mentioned embodiments. One of further possible devices is represented in the FIG. 6. Thermo-insulating cover 4 comprises like at the previous embodiments the carrier thermo-insulating segment 41 rotatably mounted on the massage pool 1 and the carried thermo-insulating segment 42. On the free wall 423 of the carried thermo-insulating segment 42 on both sides next to the side edges of the massage pool 1 are arranged drivers 80, which are coupled with endless toothed belt 10, which is wrapped around the toothed belt pulley 101, 102 arranged on side wall of the massage pool 1, while the distance between the toothed belt pulleys 101, 102 is identical or greater than the total sum of lengths of thermo-insulating segments. At least one toothed belt pulley 101 or 102 is in a known manner coupled with rotating drive 5, which may be manual or electrical. During displacement of the thermo-insulating cover 4 from the covering position into the opened position the belt pulleys 101, 102 are driven in direction towards the place of rotation of the carrier thermo-insulating segment 41, so that the driver 80 displaces in the same direction and the angle between the bottom surfaces 411 and 421 of the thermo-insulating segments 41, 42 is being changed from 180° to 0°. Once the bottom surfaces 411, 421 of the thermo-insulating segments touch one another the motion of the toothed belt 10 is stopped. At displacing the thermo-insulating cover 4 from opened position into covering position the toothed belt pulleys 101, 102 rotate in opposite direction and the toothed belt 10 carries the driver 80 into its initial position, in which the bottom surfaces 411 and 421 of the thermo-insulating segments sit on the massage pool 1. In the not represented embodiment the endless toothed belt 10 may be replaced by endless chain or by the toothed belt of definite length which in both directions rewinds between the belt pulleys on which it is partially being wound.

The FIGS. 7 to 11 represent further exemplary embodiments of the device according to the invention, serving to manual manipulation with the thermo-insulating cover 4 of the massage pool. The thermo-insulating cover 4 like at the previous embodiments comprises a pair of thermo-insulating segments 41, 42, which are rotatably connected together, and the carrier thermo-insulating segment 41 is rotatably mounted on the massage pool 1.

The device comprises the reglet 11 formed of a closed rectangled profile, in whose rear section there is from above performed a groove 111. In the represented embodiment the reglet 11 is attached on the frame 12 arranged on the shell 2 of massage pool in its upper part, nevertheless it may be attached e.g. directly on perimeter of the massage pool, possibly it may be attached to the ground next to the massage pool. Inside the reglet 11 there is mounted the gas pressure spring 13, whose cylinder 131 is firmly mounted in a section of the reglet 11 with closed profile, and whose piston rod 132 at its end is rotatably connected with the strut 14, whose second end is rotatably connected with the rotatable point 151 of the lifting arm 15, which has a cross-section in the shape of inverted letter U. The lifting arm 15 with its second end by means of the pin 152 is rotatably mounted on the carrier thermo-insulating segment 41. The strut 14 passes through the groove 111 of the reglet 11, it is made of sufficiently strong material and the shape of its cross section may be different.

On the reglet 11 or frame 12 there is directly or by means of a suitable connecting element rotatably mounted the guiding member 16, which is in a sliding manner mounted in the bushing 161, that is rotatably mounted on the side wall 412 of the carrier thermo-insulating segment 41. The guiding member 16 is at the end provided with arrestment stop 162. Locking of the guiding segment 16 with the arrestment stop 162 secures the thermo-insulating cover 4 in opened position and it prevents, upon manipulation with the thermo-insulating cover 4, turning of the thermo-insulating cover 4 in opened position in direction backwards, as well as spontaneous tilting down.

The lifting arm 15 in the place of turning point 151 is coupled with the locking means formed of elastic member 17, whose second end is mounted on the reglet 11, or frame 12, or on the massage pool 1 itself. The elastic member 17 may be formed e.g. of an elastic wire or an extension spring and it serves as a locking means preventing drawing away the lifting arm 15 from the reglet 11, thus maintaining the turning point 151 in a stable position. The elastic member 17 moreover prevents an abrupt lifting of the lifting arm 15 upon displacement of the thermo-insulating cover 4 from the covering position. For an easy manipulation with the thermo-insulating cover 4, the grip 4121 is positioned on the side wall 412 of the carrier thermo-insulating segment 41, and the grip 4221 is arranged on the side wall 422 of the carried thermo-insulating segment 42.

In covering position of the thermo-insulating cover 4 represented in the FIGS. 8 and 9 the piston rod 132 is inserted in the cylinder 131 of the gas pressure spring, the lifting arm 15 sits on the strut 14 and it overlaps it. The bushing 161 of guiding member 16 is in its lower dead centre. In the FIG. 8 the lifting arm 15 together with the strut 14 is pressed to the reglet 11 or to frame 12, and namely by means of the arrestment lever or other locking element, while in the FIG. 9 this locking element is unlocked and the turning point 151 of lifting arm is in the upper position, in which it is secured by the elastic member 17.

At mechanic displacing the thermo-insulating cover 4 from the covering position represented in the FIG. 8 into opened position, an operator first unlocks the not represented locking element, thanks to which the lifting arm 15 gets with its turning point 151 into the upper position represented in the FIG. 9. After then an operator by means of the grip 4121 of the carried thermo-insulating segment 41 lifts the thermo-insulating cover 4 from perimeter of the massage pool and after then by means of the grip 4221 of the carried thermo-insulating segment 42 manually displaces the thermo-insulating cover 4 into opened position, while the carried thermo-insulating segment 42 with its bottom surface 421 approaches to the bottom surface 411 of the carrier thermo-insulating segment, as it is represented in the FIG. 9. The angle between the bottom surfaces 411 and 421 decreases from 180° to 0°. At this displacement the piston rod 132 is extended from the cylinder 131 of gas pressure spring, while there is utilised the energy accumulated in the gas pressure spring 13 after previous displacement of the thermo-insulating cover 4 from opened position into the covering position, so that the operator develops a minimum force.

When extending the piston rod 132 of the gas pressure spring 13 by means of the strut 14 the lifting arm 15 lifts and the guiding member 16 moves with the bushing 161, which at the same time turns in corresponding manner, till the arrestment stop 162 of the guiding member 16 gets into contact with the bushing 161. This prevents further motion of guiding member 16 and due to this also of the carrier thermo-insulating segment 41, through which the carrier thermo-insulating segment 41 in its opened position is secured against reverse turning. Once the carrier thermo-insulating segment 41 gets into opened position, an operator pushes to its bottom side the carried thermo-insulating segment 42, whose free wall 423 in this phase including the travelling wheel 8 is already above the level of the border 31 of the massage pool, as represented in the FIG. 10. After pushing the carried thermo-insulating segment 42 to the carrier thermo-insulating segment 41, the bottom surfaces 411 and 421 of both thermo-insulating segments 41, 42 are seated one to another as it is represented in the FIG. 11. At mechanic displacing the thermo-insulating cover 4 into covering position, the procedure is reverse. An operator after releasing the locking means grasps the grip 4221 of the carried thermo-insulating segment 42 and draws it away gradually from the carrier thermo-insulating segment 41, at the same time developing the minimum effort, because lowering of the thermo-insulating cover 4 occurs due to gravitation. Too abrupt and fast lowering of the thermo-insulating cover 4 is prevented by resistance of the gas pressure spring 13, whose piston rod 132 inserts into the cylinder 131. The guiding member 16 shifts with the bushing 161, which rotates, and the arrestment stop 162 draws away from the bushing 161, till the guiding member 16 drops into its bottom dead centre. The invention is not limited expressly to the hereunder described or directly represented embodiments, because modification of principles of this invention for a particular design solution, including possible combinations of individual structural features, does not exceed the limits of this invention either scope of mere specialised skill. The FIG. 1 to FIG. 11 represent only several particular embodiments of the massage pool 1 and the device for manipulation with the thermo-insulating cover 4 and its parts, moreover in a simplified manner. The structure of the whole device as well as individual parts is variable and may be accommodated to a specific structure of the massage pool 1 and the thermo-insulating cover 4.

### INDUSTRIAL APPLICABILITY

The invention is applicable to displace the thermo-insulating cover between its covering position and storage position, possibly for its storing into the storage space, this not only at the massage pools but also at the swimming massage pools where especially an automatic lifting device could be applied.

### LIST OF REFERENTIAL MARKINGS

1 massage pool
2 shell of massage pool
3 vessel of massage pool
31 border of massage pool
4 thermo-insulating cover
41 carrier thermo-insulating segment
411 bottom surface of thermo-insulating segment
412 side wall of carrier thermo-insulating segment
4121 grip of carrier thermo-insulating segment
42 carried thermo-insulating segment
421 bottom surface of carried thermo-insulating segment
422 side wall of carried thermo-insulating segment
4221 grip of carried thermo-insulating segment
423 free wall of carried thermo-insulating segment
5 drive
6 air cylinder
61 bushing of air cylinder
62 piston rod
621 guide
7 guiding
8 travelling wheel
80 driver
9 storage space
91 means for lowering and extending of thermo-insulating segments
10 toothed belt
101 toothed belt pulley
102 toothed belt pulley
11 reglet
12 frame
13 gas pressure spring
131 cylinder of gas pressure spring
132 piston rod of gas pressure spring
14 strut
15 lifting arm
151 turning point of lifting arm
152 pin
16 guiding member
161 bushing
162 arrestment stop
17 elastic member

1. The method for manipulation with thermo-insulating cover of massage pool or swimming massage pool between its covering position and opened position and vice versa, while the thermo-insulating cover comprises at least one pair of thermo-insulating segments formed of carrier thermo-insulating segment and carried thermo-insulating segment, which are together rotatably connected and in covering position are lying by their bottom surfaces on circumference of the massage pool, while the carrier thermo-insulating segment is rotatably mounted on the massage pool wherein, at transition from covering into opened position the angle, which is formed by bottom surfaces of thermo-insulating segments of a pair of thermo-insulating segments, decreases from 180° in covering position to 0° in opened position, in which originally bottom surfaces of both thermo-insulating segments mutually touch, and during transition from opened into covering position the angle, which is formed by the bottom surfaces of thermo-insulating segments, increases from 0° to 180°.

2. The method according to claim 1, wherein the carried thermo-insulating segment at least on a section of its track moves by its free wall on perimeter of the massage pool.

3. The method according to claim 1, wherein upon the carrier thermo-insulating segment, the rotating drive is acting.

4. The method according to claim 3, wherein the rotating drive is manual.

5. The method according to claim 3, wherein the rotating drive is electrical.

6. The method according to claim 1, wherein upon the carrier thermo-insulating segment by a force via the carried thermo-insulating segment is acted.

7. The device for manipulation with the thermo-insulating cover of the massage pool or swimming massage pool between its covering position and opened position and vice versa, while the thermo-insulating cover comprises at least one pair of thermo-insulating segments formed of carrier thermo-insulating segment and carried thermo-insulating segment, which are together rotatably connected and in covering position are lying by their bottom surfaces on circumference of massage pool, while the carrier thermo-insulating segment is rotatably mounted on the massage pool, wherein it comprises means for decreasing an angle between the bottom surfaces of thermo-insulating segments from 180° to 0° at opening the thermo-insulating cover, and for increasing of this angle from 0° to 180° upon closing the thermo-insulating cover.

8. The device according to claim 7, wherein, the means to change an angle between the bottom surfaces of thermo-insulating segments are formed of rotating drives arranged on both sides of carrier thermo-insulating segment.

9. The device according to claim 8, wherein, the carrier thermo-insulating segment on each its side wall is provided with rotatably mounted air cylinder, whose piston rod at the end is provided with the guide, which is displaceably mounted in guiding arranged on the respective side wall of the carried thermo-insulating segment.

10. The device according to claim 7, wherein, the thermo-insulating segments in their opened position are coupled with the means for lowering of their thermo-insulating segments into their storage position in the storage space and for extending of the thermo-insulating segments backwards into their opened position.

11. The device according to claim 7, wherein, the means for changing the angle between the bottom surfaces of the thermo-insulating segments comprise the gas pressure spring, whose cylinder is mounted on the massage pool and the piston rod is coupled with the carrier thermo-insulating segment.

12. The device according to claim 11, wherein, the cylinder of the gas pressure spring on the massage pool is mounted in a fixed manner and the piston rod is rotatably connected with the strut, which is connected with the turning point of the lifting arm, whose second end is by means of the pin rotatably mounted on the carrier thermo-insulating segment, while on the massage pool is rotatably mounted the guiding member, which is in a sliding manner mounted in the bushing, which is rotatably mounted on the side wall of the carrier thermo-insulating segment.

13. The device according to claim 12, wherein, the guiding member on its end is provided with the arrestment stop.
